(19) United States
(12) Patent Application Publication
(10) Pub. No.: US 2022/0062809 A1
(43) Pub. Date: Mar. 3, 2022

(54) FILTER SUPPORT SYSTEM HAVING AN ANTI-MICROBIAL COMPONENT

(71) Applicant: Roger Richter, (US)

(72) Inventors: Roger Richter, Omaha, NE (US); Shawn VanFossen, Auburn, KS (US)

(21) Appl. No.: 17/010,753

(22) Filed: Sep. 2, 2020

(51) Int. Cl. B01D 46/00

(52) U.S. Cl. CPC B01D 46/0002; B01D 2239/0442

(57) ABSTRACT

A filter support system may include, but is not limited to: an anti-microbial mesh; and a frame configured to at least partially retain a filter such that at least a portion of fluid flow through the filter interacts with the anti-microbial mesh. The anti-microbial mesh may be constructed at least partially from a copper-containing material.

### FIELD OF THE INVENTION

The invention relates generally to the field of residential, commercial, industrial and/or automotive filtration systems.

### BRIEF DESCRIPTION OF THE DRAWINGS

The numerous advantages of the disclosure may be better understood by those skilled in the art by reference to the accompanying figures in which:

FIG. 1 shows a filter support system having an anti-microbial component;

FIG. 2 shows a filter support system having an anti-microbial component;

FIG. 3 shows a filter support system having an anti-microbial component;

FIG. 4 shows a filter support system having an anti-microbial component; and

FIG. 5 shows a filter support system having an anti-microbial component.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures, components and materials have not been described in detail so as not to unnecessarily obscure aspects of the present invention.

The technical proposal(s) of embodiments of the present invention will be fully and clearly described in conjunction with the drawings in the following embodiments. It will be understood that the descriptions are not intended to limit the invention to these embodiments. Based on the described embodiments of the present invention, other embodiments can be obtained by one skilled in the art without creative contribution and are in the scope of legal protection given to the present invention.

Furthermore, all characteristics, measures or processes disclosed in this document, except characteristics and/or processes that are mutually exclusive, can be combined in any manner and in any combination possible. Any characteristic disclosed in the present specification, claims, Abstract and Figures can be replaced by other equivalent characteristics or characteristics with similar objectives, purposes and/or functions, unless specified otherwise.

The advantages of the present invention will become readily apparent from the detailed description of various embodiments below.

Bacteria, yeasts, viruses, and other potential bio-contaminants may be rapidly deactivated when brought into contact with or retained on surfaces including various metal components and/or coatings. As such, these materials may be employed as an anti-microbial and/or disinfecting component in various products. For example, copper and its alloys (brasses, bronzes, cupronickel, copper-nickel-zinc, and the like), silver, or any human-touch safe anti-microbial coating may be employed on high-touch surfaces, such as door handles, bathroom fixtures, or bed rails, in attempts to curb infectious transmissions.

In a further example, anti-microbial structures may be employed in concert with various heating, ventilation, and air conditioning (HVAC) to remove or deactivate such bio-contaminants present in an ambient environment (e.g. homes, businesses, schools, hospitals, arenas, concert halls, theaters, schools, gymnasiums, exposition/convention centers, shopping centers, airports, industrial facilities, and the like) in which large numbers of patrons or personnel may periodically visit and that, in order to create/maintain a clean environment for such individuals, should be sanitized to avoid transmission of communicable diseases.

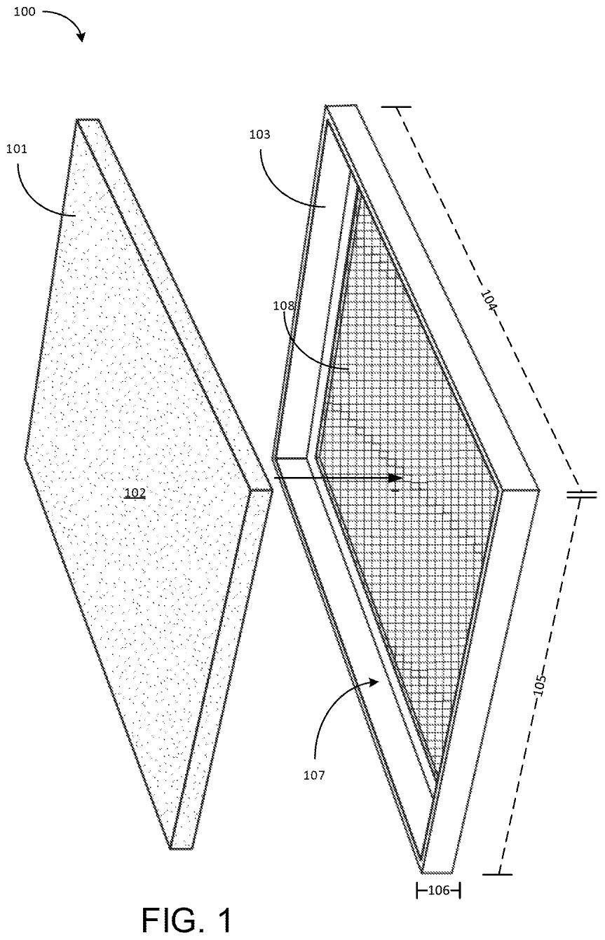

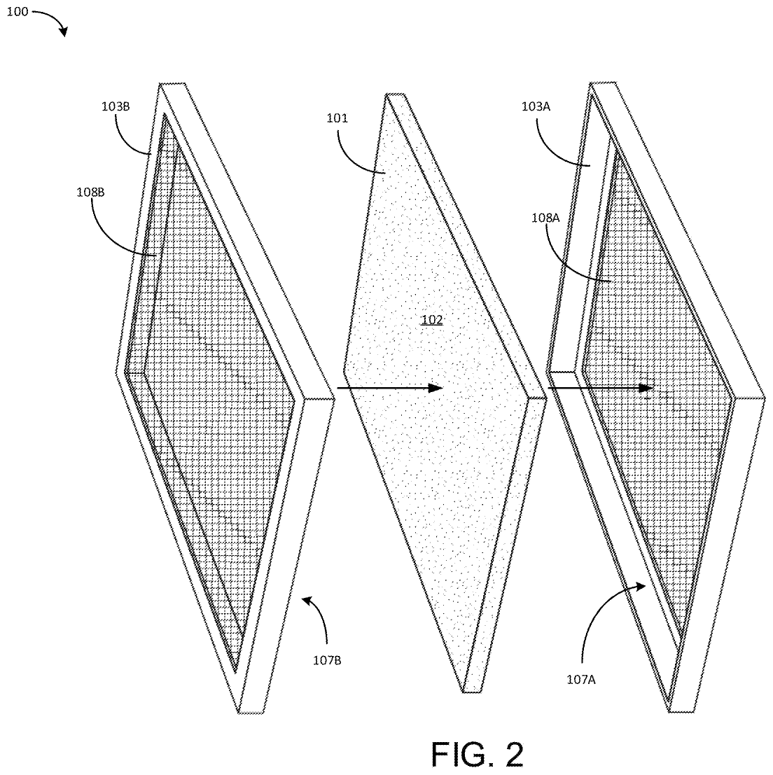

Referring to FIGS. 1-2, a system 100 for filtering and deactivation of bio-contaminants from an ambient environment is shown. The system 100 may include at least one filter 101. The filter 101 may include a membrane 102 constructed of a material (e.g. a cloth, fabric, plastic fiber (e.g. fiberglass), electrostatic, and the like) configured to permit fluid flow (e.g. airflow) through the membrane 102 while filtering and/or retaining particulate materials entrained within the fluid flow so as to purify the fluid flow. For example, the filter 101 may be selected from any number of original equipment manufacturer (OEM) HVAC air filters such as those manufactured by AIRx™, Honeywell™, Filtrete™, and the like.

The system 100 may further include at least one frame 103. The frame 103 may be sized such that it has a height 104, width 105, and depth 106 defining a recess 107 large enough to receive the filter 101 at least partially within the frame 103. Such a configuration may allow for the insertion of both the frame 103 and the filter 101 into a standard HVAC or other fluid flow conduit port (e.g. a residential or commercial HVAC filter slot).

The system 100 may further include an anti-microbial mesh 108. The anti-microbial mesh 108 (e.g. a network of interlaced fibers and/or wire portions) may be constructed at least partially of an anti-microbial material. In one embodiment, the anti-microbial mesh 108 may be at least partially constructed from an anti-microbial metal. In another embodiment, the anti-microbial mesh 108 may be at least partially constructed from a copper-containing material. In another embodiment, the anti-microbial mesh 108 may be at least partially constructed of copper metal. In another embodiment, the anti-microbial mesh 108 may be at least partially constructed of a copper alloy. In another embodiment, the anti-microbial mesh 108 may be at least partially constructed of substrate at least partially coated with an anti-microbial coating.

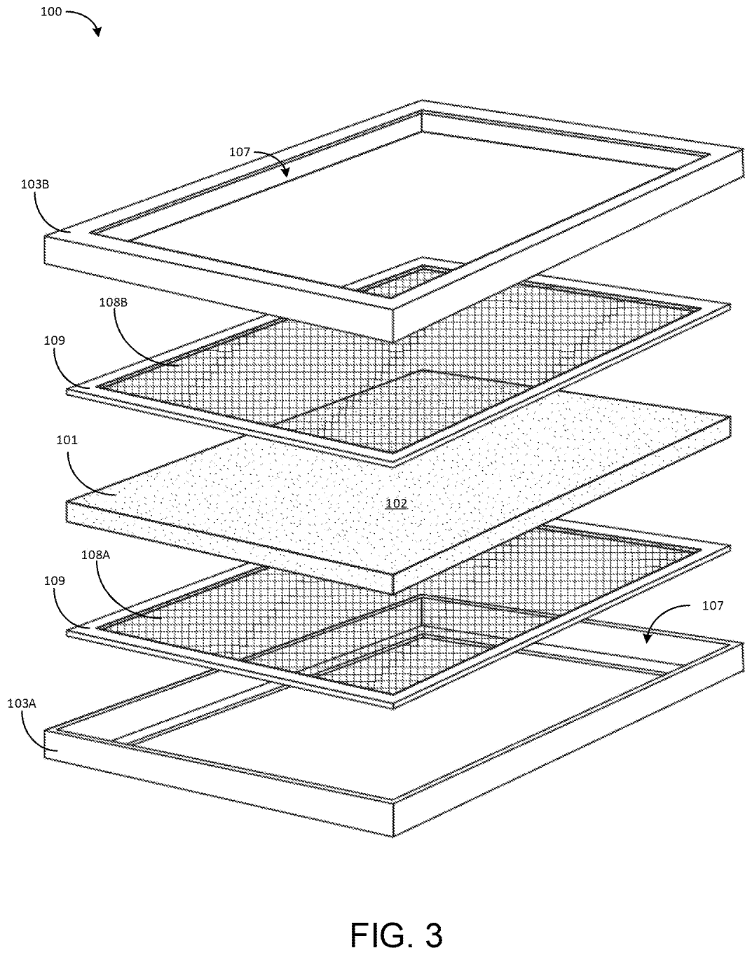

As shown in FIGS. 1 and 2, the anti-microbial mesh 108 may be directly coupled the frame 103 (e.g. via mechanical coupling, adhesive, welding, and the like). Alternately, as shown in FIG. 3, the anti-microbial mesh 108 may be coupled (e.g. via mechanical coupling, adhesive, welding, and the like) to a subframe 109 which, in turn, may be receivable within the recess 107 defined by a frame 103.

Referring again to FIG. 1, the system 100 may include a single frame 103 configured to receive the filter 101. The frame 103 may further include at least one retention mechanism (not shown) configured to retain the filter 101 at least partially within the frame 103. For example, the frame 103 may include one or more clips, straps, hooks, frictional contact portions, or other structures configured to retain the filter 101 at least partially within the frame 103.

Referring to FIGS. 2 and 3, the system 100 may include at first frame portion 103A and a second frame portion 103B, including (e.g. receiving or coupled to) a first anti-microbial mesh portion 108A and a second anti-microbial mesh portion 108B, respectively, configured to cooperatively receive and/or retain the filter 101. Such a dual-frame, dual-mesh configuration may provide for increased surface area for interaction of fluid flow with the anti-microbial material of the first anti-microbial mesh portion 108A and the second anti-microbial mesh portion 108B. In one embodiment, the first frame portion 103A may define a recess 107A configured to at least partially receive the filter 101; the second frame portion 103B may define a recess 107B configured to at least partially receive both the first frame portion 103A and the filter 101 (e.g. inset at least partially within the second frame portion 103B). In another embodiment, the first frame portion 103A and the second frame portion 103B may be disposed adjacent to the filter 101 so as to sandwich the filter 101 between the first anti-microbial mesh portion 108A and the second anti-microbial mesh portion 108B. The first frame portion 103A and the second frame portion 1038 may then be coupled together to retain the filter 101 therebetween.

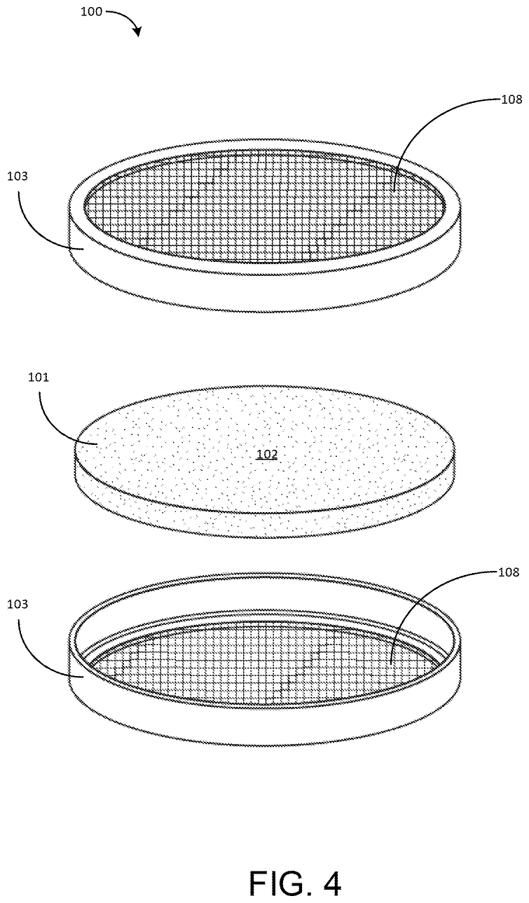

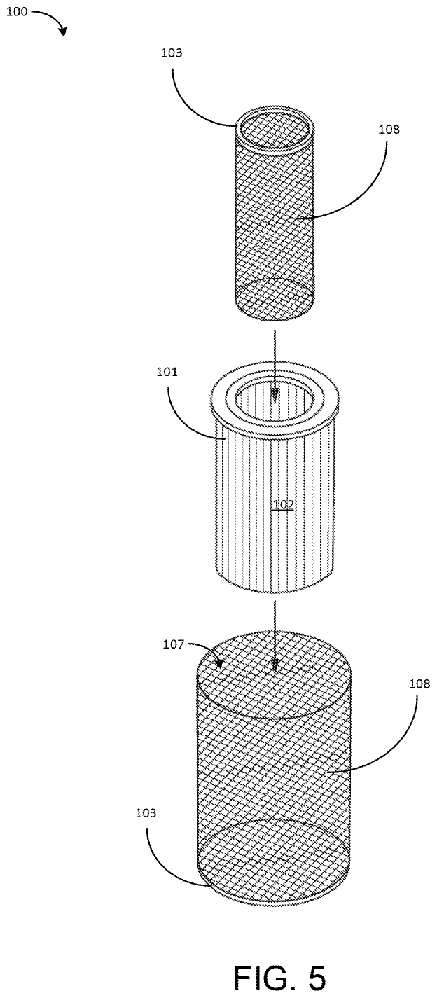

As shown in FIGS. 1-3, the frame 103 and/or the anti-microbial mesh 108 may have a rectilinear form factor substantially corresponding to a form factor of the filter 101. However, as shown in FIGS. 4 and 5, the frame 103 and/or the anti-microbial mesh 108 may be configured to correspond to a filter 101 having any form factor such that fluid flow through the filter 101 will interact with the anti-microbial mesh 108. For example, as shown in FIG. 4, the frame 103 and/or the anti-microbial mesh 108 may have a circular configuration so as to receive a circular filter 101. Alternately, as shown in FIG. 5, the frame 103 may support an anti-microbial mesh 108 having an at least partially cylindrical configuration so as to correspond to a cylindrical filter 101.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed:

1. A system including:
an anti-microbial mesh; and
a frame configured to at least partially receive a filter such that at least a portion of fluid flow through the filter interacts with the anti-microbial mesh.

2. The system of claim 1, wherein the anti-microbial mesh includes:
an anti-microbial mesh constructed at least partially from an anti-microbial material.

3. The system of claim 2, wherein the anti-microbial mesh constructed at least partially of an anti-microbial material includes:
an anti-microbial mesh constructed at least partially from an anti-microbial metal.

4. The system of claim 3, wherein the anti-microbial mesh constructed at least partially of an anti-microbial metal includes:
an anti-microbial mesh constructed at least partially from a copper-containing material.

5. The system of claim 4, wherein the anti-microbial mesh constructed at least partially of a copper-containing material includes:
an anti-microbial mesh consisting essentially of copper metal.

6. The system of claim 4, wherein the anti-microbial mesh constructed at least partially of a copper-containing material includes:
an anti-microbial mesh constructed at least partially from a copper alloy.

7. The system of claim 1, wherein the anti-microbial mesh includes:
an anti-microbial mesh including a substrate at least partially coated with an anti-microbial material.

8. The system of claim 1, wherein the frame configured to at least partially receive a filter includes:
a frame portion defining a recess configured to at partially receive the filter.

9. The system of claim 1, wherein the frame configured to at least partially receive a filter includes:
a first frame portion; and
a second frame portion.

10. The system of claim 8, wherein the first frame portion and the second frame portion include:
a first frame portion defining a recess configured to at least partially receive both the filter and the second frame portion.

11. The system of claim 1, wherein the frame configured to at least partially receive a filter includes:
a rectilinear frame supporting a substantially planar anti-microbial mesh.

12. The system of claim 1, wherein the frame configured to at least partially receive a filter includes:
a frame supporting an at least partially cylindrical anti-microbial mesh.

13. The system of claim 1, further comprising:
a filter configured to be received at least partially within the frame.
